(19) United States
(12) Patent Application Publication
(10) Pub. No.: US 2025/0208070 A1
(43) Pub. Date: Jun. 26, 2025

(54) IDENTIFICATION DEVICE, IDENTIFICATION METHOD, AND IDENTIFICATION PROGRAM FOR IDENTIFYING VOID IN COMPOSITE MATERIAL

(71) Applicant: IHI Corporation, Tokyo (JP)

(72) Inventor: Takanori KAMAGATA, Tokyo (JP)

(73) Assignee: IHI Corporation, Tokyo (JP)

(21) Appl. No.: 19/073,156

(22) Filed: Mar. 7, 2025

Related U.S. Application Data
(63) Continuation of application No. PCT/JP2023/037693, filed on Oct. 18, 2023.

(30) Foreign Application Priority Data
Nov. 9, 2022 (JP) 2022-179741

(51) Int. Cl. G01N 23/18; G01N 23/046; G01N 23/083

(52) U.S. Cl. CPC G01N 23/18; G01N 23/046; G01N 23/083

(57) ABSTRACT

An identification device, an identification method, and an identification program receive a physical quantity distribution of a member before impregnating matrix as a first physical quantity distribution, receive the physical quantity distribution of the member after impregnating the matrix as a second physical quantity distribution, perform a first threshold processing based on the first physical quantity distribution to generate a first structure data indicating a structure of the reinforcing material inside the member, perform a second threshold processing based on the second physical quantity distribution to generate a second structure data indicating a structure of the matrix inside the member, and identify the voids inside the member after impregnating the matrix based on a synthetic data obtained by superimposing the first structure data and the second structure data.

### CROSS REFERENCE TO RELATED APPLICATIONS

This application is a continuation application of International Application No. PCT/JP2023/037693, filed on Oct. 18, 2023, which claims priority to Japanese Patent Application No. 2022-179741, filed on Nov. 9, 2022, the entire contents of which are incorporated by reference herein.

### TECHNICAL FIELD

The present disclosure relates to an identification device, an identification method, and an identification program for identifying a void in a composite material.

### BACKGROUND ART

Patent Literature 1 discloses a technique for extracting voids from a three-dimensional image obtained by imaging a fiber-reinforced composite material with an X-ray Computed Tomography device. According to this technique, the three-dimensional image is binarized to generate a binary image, and the binary image is distance-transformed to generate a distance image. Then, a closing process is performed on the binary image using the distance image, and voids are extracted from the difference between the images before and after the closing process.

### CITATION LIST

### Patent Literature

Patent Literature 1: Japanese Patent Laid-Open Publication No. 2015-068755

### SUMMARY OF THE INVENTION

### Technical Problem

For example, when a composite material including a reinforcing material and a matrix (base material) having a higher specific gravity than the reinforcing material is imaged by an X-ray Computed Tomography device, the difference between the X-ray attenuation coefficient of the matrix and the X-ray attenuation coefficient of the reinforcing material or voids (void-like defects occurring in the composite material) is large. Therefore, when imaging is performed under imaging conditions targeting the matrix, the luminance difference between the reinforcing material portion and the void portion in the captured image becomes small, which causes a problem that the void content ratio cannot be appropriately evaluated.

The present disclosure has been made in view of the above-mentioned circumstances. In other words, the present disclosure aims to provide an identification device, an identification method, and an identification program that can identify voids contained in a composite material including reinforcing material and matrix, and can evaluate the void content ratio with high accuracy.

### Solution to Problem

An identification device of the present disclosure comprises a receiving unit configured to receive a physical quantity distribution inside a member into which a reinforcing material has been molded, and a controller configured to identify voids contained in the member based on the physical quantity distribution. The controller receives the physical quantity distribution of the member before impregnating matrix as a first physical quantity distribution through the receiving unit, receives the physical quantity distribution of the member after impregnating the matrix as a second physical quantity distribution through the receiving unit, performs a first threshold processing based on the first physical quantity distribution to generate a first structure data indicating a structure of the reinforcing material inside the member, performs a second threshold processing based on the second physical quantity distribution to generate a second structure data indicating a structure of the matrix inside the member, generates a synthetic data by superimposing the first structure data and the second structure data, and identifies the voids inside the member after impregnating the matrix based on the synthetic data.

The controller may generate the synthetic data by superimposing the first structure data and the second structure data on a basis of a design data of the member or a three-dimensional measurement data of the member.

The controller may perform a morphology processing on the synthetic data obtained by superimposing the first structure data and the second structure data to generate a modified synthetic data. Then, the controller may identify the voids based on the modified synthetic data.

The matrix may have a higher specific gravity than the reinforcing material.

The reinforcing material may be made of a plurality of fiber bundles.

The receiving unit may receive as the physical quantity distribution a distribution representing an absorbance of X-rays at each point inside the member, the distribution being acquired by an X-ray Computed Tomography device.

An identification method of the present disclosure identifies voids contained in a member based on a physical quantity distribution inside the member into which a reinforcing material has been molded, receiving the physical quantity distribution of the member before impregnating matrix as a first physical quantity distribution, receiving the physical quantity distribution of the member after impregnating the matrix as a second physical quantity distribution, performing a first threshold processing based on the first physical quantity distribution to generate a first structure data indicating a structure of the reinforcing material inside the member, performing a second threshold processing based on the second physical quantity distribution to generate a second structure data indicating a structure of the matrix inside the member, generating a synthetic data by superimposing the first structure data and the second structure data, and identifying the voids inside the member after impregnating the matrix based on the synthetic data.

An identification program of the present disclosure identifies voids contained in a member based on a physical quantity distribution inside the member into which a reinforcing material has been molded. Then, the computer is caused to execute a step of receiving the physical quantity distribution of the member before impregnating matrix as a first physical quantity distribution. The computer is caused to execute a step of receiving the physical quantity distribution of the member after impregnating the matrix as a second physical quantity distribution. The computer is caused to execute a step of performing a first threshold processing based on the first physical quantity distribution to generate a first structure data indicating a structure of the reinforcing material inside the member. The computer is caused to execute a step of performing a second threshold processing based on the second physical quantity distribution to generate a second structure data indicating a structure of the matrix inside the member. The computer is caused to execute a step of generating a synthetic data by superimposing the first structure data and the second structure data. The computer is caused to execute a step of identifying the voids inside the member after impregnating the matrix based on the synthetic data.

### Advantageous Effects of Invention

According to the present disclosure, it is possible to identify voids contained in a composite material including reinforcing material and matrix, and to evaluate the void content ratio with high accuracy.

### BRIEF DESCRIPTION OF DRAWINGS

FIG. 1 is a block diagram showing a configuration of an identification device according to an embodiment of the present disclosure.

FIG. 2 is a flowchart showing a processing procedure of the identification device according to the embodiment of the present disclosure.

### DESCRIPTION OF EMBODIMENTS

Hereinafter, some exemplary embodiments will be described with reference to the drawings. In addition, common parts in the figures are given the same reference numerals, and duplicated explanations will be omitted.

### Subject of Processing by the Identification Device

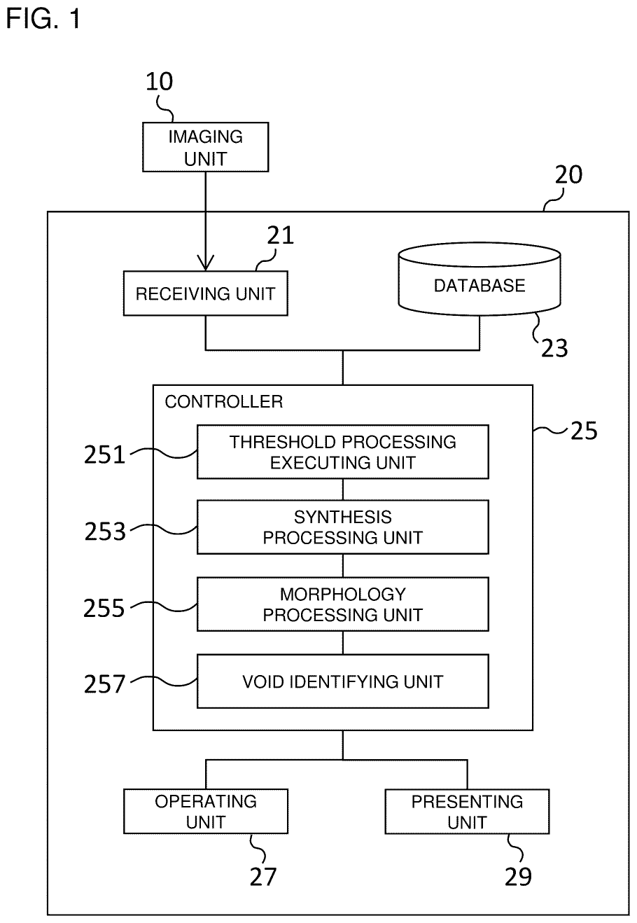

As shown in FIG. 1, the identification device 20 is connected to the imaging unit 10. Here, the imaging unit 10 irradiates X-rays onto the member to be measured, and by detecting the X-rays that have passed through, obtains the physical quantity distribution inside the member.

For example, the imaging unit 10 is an X-ray Computed Tomography device. In this case, the physical quantity distribution inside the member is acquired by imaging with the imaging unit 10. The “physical quantity distribution” inside the member represents the luminance at each point inside the member. The luminance at each point inside the member is associated with the absorbance of X-rays or the degree of attenuation of X-rays at each point.

The member (composite material) from which the physical quantity distribution is acquired by the imaging unit 10 is obtained by impregnating a molded reinforcing material with a matrix (base material) to compound the reinforcing material and the matrix. The reinforcing material is, for example, graphite, boron nitride, or ceramics such as silicon carbide. The reinforcing material may be a resin such as Kevlar (registered trademark), or an appropriate metal or alloy. The reinforcing material may be made of a plurality of fiber bundles.

The matrix is, for example, a thermosetting resin, a thermoplastic resin, or a ceramic such as silicon carbide. For example, the matrix may have a higher specific gravity than the reinforcing material, and the difference between the X-ray attenuation coefficient of the matrix and the X-ray attenuation coefficient of the reinforcing material or voids (void-like defects occurring in a member) may be large. A member whose matrix is made of ceramic is particularly called a ceramic matrix composite material (CMC).

By using the imaging unit 10, a physical quantity distribution of the member before impregnated with the matrix is acquired as a first physical quantity distribution, and a physical quantity distribution of the member after impregnated with the matrix is acquired as a second physical quantity distribution. As will be described later, the identification device 20 has a function of identifying voids contained in the member based on the first physical quantity distribution and the second physical quantity distribution acquired by the imaging unit 10.

### Configuration of the Identification Device

FIG. 1 is a block diagram showing the configuration of the identification device 20. The identification device 20 comprises a receiving unit 21 (receiver), a database 23 (storage unit), a controller 25, an operating unit 27, and a presenting unit 29. The controller 25 is connected to the receiving unit 21, the database 23, the operating unit 27, and the presenting unit 29 so as to be able to communicate with them.

In addition, the operating unit 27 and the presenting unit 29 may be provided in the identification device 20 itself, or may be installed outside the identification device 20 and connected to the identification device 20.

The receiving unit 21 is connected wirelessly or wired so as to be able to communicate with the imaging unit 10. The receiving unit 21 receives data indicating the first physical quantity distribution and data indicating the second physical quantity distribution from the imaging unit 10.

Furthermore, the receiving unit 21 may receive data indicating the first physical quantity distribution or data indicating the second physical quantity distribution from a storage medium, etc. In this case, the data indicating the first physical quantity distribution or the data indicating the second physical quantity distribution stored in the storage medium, etc. may be measured using the imaging unit 10 that is not connected to the identification device 20.

Alternatively, the receiving unit 21 may receive design data of the member or three-dimensional measurement data of the member. The design data of the member is, for example, data generated by CAD (Computer-aided design) when designing the member. The three-dimensional measurement data of the member is, for example, data indicating the outer shape of the member obtained by actually measuring the member using a three-dimensional measuring device.

The database 23 stores the data indicating the first physical quantity distribution and the data indicating the second physical quantity distribution received by the imaging unit 10. In addition, the database 23 may store a timestamp specifying the date and time of imaging by the imaging unit 10, an identification number specifying the member that was the subject of measurement by the imaging unit 10, and the like, together with the received data.

The operating unit 27 is an input device that can be operated by a user, such as a monitor or maintenance person of the evaluation system. For example, the operating unit 27 is a keyboard, a mouse, a trackball, a touch panel, or the like. The operating unit 27 is not limited to the examples given here. The content of the user's operation input via the operating unit 27 is transmitted to the controller 25.

The presenting unit 29 displays the information generated by the controller 25. The presenting unit 29 may also present to the user the distribution of voids inside the member extracted by the controller 25, which will be described later. For example, the presenting unit 29 may be a display that displays figures and characters by combining a plurality of display pixels. The presenting unit 29 is not limited to the examples given here.

The identification device 20 may include an output unit that outputs the information generated by the controller 25 to the outside of the identification device 20. That is, the identification device 20 may include the output unit that outputs data indicating the distribution of voids inside the member.

The controller 25 (control unit) is a general-purpose microcomputer equipped with a CPU (Central Processing Unit), a memory, and an input/output unit. A computer program (identification program) for functioning as the identification device 20 is installed in the controller 25. By executing the computer program, the controller 25 functions as a plurality of information processing circuits (251, 253, 255, 257) equipped in the identification device 20. The computer program may be stored in a storage medium that can be read and written by a computer. Alternatively, the computer program may be capable of being distributed via a telecommunication line.

In the present disclosure, an example is shown in which multiple information processing circuits (251, 253, 255, 257) are realized by software. However, it is also possible to prepare dedicated hardware for executing each information process shown below and configure the information processing circuits (251, 253, 255, 257). In addition, the multiple information processing circuits (251, 253, 255, 257) may be configured by individual hardware. Furthermore, the information processing circuits (251, 253, 255, 257) may also be used as a control unit used for monitoring or controlling the imaging unit 10.

As shown in FIG. 1, the controller 25 includes a threshold processing executing unit 251, a synthesis processing unit 253, a morphology processing unit 255, and a void identifying unit 257 as a plurality of information processing circuits (251, 253, 255, 257). Note that the morphology processing unit 255 may be omitted.

The threshold processing executing unit 251 performs a first threshold processing based on the first physical quantity distribution to generate first structure data indicating the structure of the reinforcing material inside the member. Here, the first threshold processing is a process for identifying cells (pixels or voxels) having a physical quantity equal to or greater than a first threshold as cells in which the reinforcing material is present, and identifying cells having a physical quantity less than the first threshold as cells in which the reinforcing material is not present, based on the first physical quantity distribution. The first threshold is appropriately set based on the shooting conditions in the imaging unit 10.

In the first physical quantity distribution, there is a difference in luminance between the cells in which the reinforcing material is present and the cells in which the reinforcing material is not present. Thus, by appropriately setting the first threshold based on imaging conditions in the imaging unit 10, it is possible to distinguish between the cells in which the reinforcing material is present and the cells in which the reinforcing material is not present. Therefore, it is possible to prevent a cell in which the matrix or the void is present after the matrix is impregnated from being erroneously identified as a cell in which the reinforcing material is present.

Furthermore, the threshold processing executing unit 251 performs a second threshold processing based on the second physical quantity distribution to generate second structure data indicating the structure of the matrix inside the member. Here, the second threshold processing is a process for identifying a cell having a physical quantity equal to or greater than a second threshold as a cell in which the matrix exists, and identifying a cell having a physical quantity less than the second threshold as a cell in which the matrix does not exist, based on the second physical quantity distribution. The second threshold is appropriately set based on the imaging conditions in the imaging unit 10.

In the second physical quantity distribution, there is a difference in luminance between a cell in which the matrix exists and a cell in which the matrix does not exist. Thus, by appropriately setting the second threshold based on the imaging conditions in the imaging unit 10, it is possible to distinguish between a cell in which the matrix exists and a cell in which the matrix does not exist. Therefore, it is possible to prevent a cell in which the matrix exists from being erroneously identified as a cell in which the reinforcing material or the void exists.

It should be noted that it is difficult to identify, among the cells in which no matrix exists, the cells in which the reinforcing material exists and the cells in which the reinforcing material does not exist (i.e., the cells in which the void exists) based on the second physical quantity distribution. The reason why it is difficult to identify above, when imaging is performed under imaging conditions targeting the matrix, the difference between luminance of the cells in which the reinforcing material exists and luminance of the cells in which the void exists becomes small.

In other words, when imaging is performed under imaging conditions targeting the matrix, it becomes difficult to distinguish between cells in which the reinforcing material exists and cells in which the void exists. Therefore, the threshold processing executing unit 251 performs both the first threshold processing based on the first physical quantity distribution and the second threshold processing based on the second physical quantity distribution.

The synthesis processing unit 253 generates synthetic data by superimposing the first structure data and the second structure data.

For example, when imaging by the imaging unit 10, imaging may be performed so that a protruding structure of the member (including three orthogonal planes) for data alignment that is intentionally added and through which X-ray CT easily penetrates and which is unlikely to cause scattered light is captured. The synthesis processing unit 253 may generate the synthetic data by superimposing the first structure data and the second structure data based on the image of the protruding structure.

Furthermore, when capturing an image by the imaging unit 10, a jig such as a ceramic ball may be placed on the surface of the member, and the member may be captured together with the jig. The synthesis processing unit 253 may generate the synthetic data by superimposing the first structure data and the second structure data on the basis of the captured image of the jig.

Alternatively, the synthesis processing unit 253 may generate the synthetic data by superimposing the first structure data and the second structure data based on the design data of the member or the three-dimensional measurement data of the member.

The synthesis processing unit 253 generates the synthetic data such that cells in the first structure data that correspond to cells in which reinforcing material exists are identified as reinforcing material cells in the synthetic data. Then, the synthesis processing unit 253 generates the synthetic data such that cells in the second structure data that correspond to cells in which the matrix exists are identified as matrix cells in the synthetic data.

On the other hand, the synthesis processing unit 253 generates the synthetic data such that, among the cells that are neither reinforcing material nor matrix, cells that exist inside the member are identified as void cells. The synthesis processing unit 253 may determine whether or not a cell exists inside the member based on the design data of the member or the surface position of the member specified by the three-dimensional measurement data of the member. In other words, the synthesis processing unit 253 may determine that a void cell surrounded by a closed surface that is the surface of the member is a void cell that exists inside the member.

Furthermore, the synthesis processing unit 253 may determine that a void cell surrounded by cells of the reinforcing material or the matrix is a void cell present inside the member.

The morphology processing unit 255 performs morphology processing on the synthetic data to generate modified synthetic data. For example, the morphology processing unit 255 performs “Erosion” process or “Dilation” process as the morphology processing. In particular, the morphology processing unit 255 performs morphology processing on any one type of cell among reinforcing material cells, matrix cells, and void cells included in the synthetic data.

The morphology processing unit 255 may repeatedly perform the “Erosion” processing and the “Dilation” processing a predetermined number of times. The morphology processing unit 255 may perform the “Erosion” process and the “Dilation” process in combination. By performing the “Erosion” process, it is possible to remove isolated cells included in the synthetic data. Also, by performing the “Dilation” process, it is possible to connect discontinuous cells and fill in holes in cells.

The morphology processing unit 255 may perform an “Opening” process or a “Closing” process. The “Opening” process is a process in which a predetermined number of “Erosion” processes are successively performed, followed by a predetermined number of “Dilation” processes. The “Closing” process is a process in which a predetermined number of “Dilation” processes are successively performed, followed by a predetermined number of “Erosion” processes.

The morphology processing can remove noise contained in the synthetic data. The morphology processing can detect voids that are open to the outside of the member. Even if a continuous structure is actually expressed as a discontinuous structure in the synthetic data, the morphology processing can correct the discontinuous parts to a continuous structure and make it possible to extract fine structures.

The morphology processing unit 255 may perform the morphology processing on the first structure data to update the first structure data. The morphology processing unit 255 may perform the morphology processing on the second structure data to update the second structure data.

The void identifying unit 257 identifies voids in the member after the matrix is impregnated based on the synthetic data or the modified synthetic data. That is, the void identifying unit 257 extracts cells identified as void cells in the synthetic data or the modified synthetic data, and generates data indicating the distribution of the extracted cells. Then, the void identifying unit 257 may calculate a content ratio of the void in the member after the matrix is impregnated based on the distribution of the identified voids. The content ratio of the void is a numerical value indicating the proportion of void cells among the cells present inside the member.

Alternatively, the void identifying unit 257 may identify the distribution of the reinforcing material or the distribution of the matrix inside the member after the matrix is impregnated based on the synthetic data or the modified synthetic data. The void identifying unit 257 may calculate a content ratio of the reinforcing material and a content ratio of the matrix. The content ratio of the reinforcing material and the content ratio of the matrix are defined based on the cells of the reinforcing material and the cells of the matrix, respectively, similar to the content ratio of the void.

### Processing Procedure of Identification Device

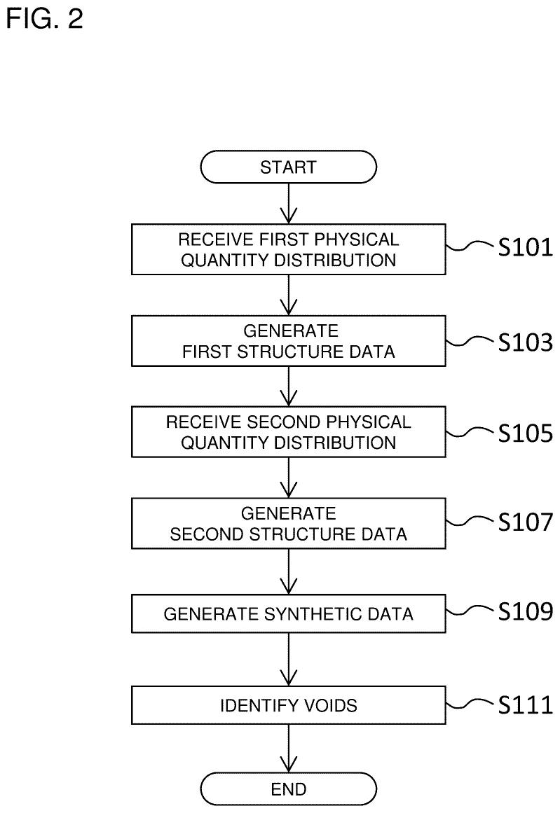

Next, a processing procedure of the identification device 20 according to the present disclosure will be described with reference to the flowchart of FIG. 2. The processing of the flowchart shown in FIG. 2 is started based on, for example, a user instruction.

In step S101, the receiving unit 21 receives the first physical quantity distribution from the imaging unit 10.

In step S103, the threshold processing executing unit 251 performs the first threshold processing based on the first physical quantity distribution to generate the first structure data. The morphology processing unit 255 may perform the morphology processing on the first structure data to update the first structure data.

In step S105, the receiving unit 21 receives the second physical quantity distribution from the imaging unit 10.

In step S107, the threshold processing executing unit 251 performs the second threshold processing based on the second physical quantity distribution to generate the second structure data. The morphology processing unit 255 may perform the morphology processing on the second structure data to update the second structure data.

In step S109, the synthesis processing unit 253 generates the synthetic data by superimposing the first structure data and the second structure data. The morphology processing unit 255 may perform the morphology processing on the synthetic data to generate the modified synthetic data.

In step S111, the void identifying unit 257 identifies voids in the member after the matrix is impregnated. The void identifying unit 257 may calculate the content ratio of the void in the member after the matrix is impregnated based on the distribution of the identified voids.

### Effect of Embodiments

As explained in detail above, an identification device, an identification method, and an identification program according to the present disclosure receives the physical quantity distribution of the member before impregnating matrix as a first physical quantity distribution, receives the physical quantity distribution of the member after impregnating the matrix as a second physical quantity distribution, performs a first threshold processing based on the first physical quantity distribution to generate a first structure data indicating a structure of the reinforcing material inside the member, performs a second threshold processing based on the second physical quantity distribution to generate a second structure data indicating a structure of the matrix inside the member, and identifies the voids inside the member after impregnating the matrix based on a synthetic data generated by superimposing the first structure data and the second structure data.

This makes it possible to identify voids contained in a composite material containing a reinforcing material and a matrix, and to evaluate the void content ratio with high accuracy.

For example, in a member containing a high specific gravity matrix, the difference in X-ray attenuation coefficient between the matrix and the reinforcing material or voids (void-like defects occurring in a composite material) is large. Thus, in an image taken under imaging conditions targeting the matrix, the difference in luminance between the reinforcing material and the voids becomes small, which makes it difficult to properly evaluate the void content ratio.

However, according to the identification device, the identification method, and the identification program according to the present disclosure, the first threshold processing based on the first physical quantity distribution and the second threshold processing based on the second physical quantity distribution are both performed, thereby solving the problem of the small luminance difference between the reinforcing material portion and the void portion. As a result, it is possible to accurately distinguish between the three types of regions present inside the member, that is, the reinforcing material, the matrix, and the void.

In the identification device, the identification method, and the identification program according to the present disclosure, the synthetic data may be generated by superimposing the first structure data and the second structure data on a basis of a design data of the member or a three-dimensional measurement data of the member. This makes it possible to accurately superimpose the first structure data and the second structure data to generate the synthetic data even when the position of the surface of the member cannot be accurately identified due to noise such as scattered light. As a result, it is possible to accurately distinguish between three types of regions, i.e., the reinforcing material, the matrix, and the voids, present inside the member.

In the identification device, the identification method, and the identification program according to the present disclosure, a modified synthetic data may be generated by performing a morphology processing on the synthetic data obtained by superimposing the first structure data and the second structure data. Then, the void may be identified based on the modified synthetic data. This makes it possible to remove noise contained in the synthetic data. Also, it is possible to detect voids that are open to the outside of the member. Furthermore, even if a structure that is actually continuous is expressed as a discontinuous structure in the synthetic data, the morphology processing makes it possible to correct the discontinuous portions to a continuous structure and extract fine structures.

In the identification device, the identification method, and the identification program according to the present disclosure, the matrix may have a higher specific gravity than the reinforcing material. According to the identification device, the identification method, and the identification program according to the present disclosure, even for a member that includes the matrix with the high specific gravity, voids inside the member can be identified and the void content ratio can be evaluated with high accuracy.

In the identification device, the identification method, and the identification program according to the present disclosure, the reinforcing material may be made of a plurality of fiber bundles. Thus, it is possible to reduce fragility of the member.

In the identification device, the identification method, and the identification program according to the present disclosure, a distribution representing an absorbance of X-rays at each point inside the member may be received as the physical quantity distribution, the distribution being acquired by an X-ray Computed Tomography device. This allows the physical quantity distribution to be acquired by penetrating the inside of the member. As a result, it is possible to identify voids included in a composite material including the reinforcing material and the matrix, and to evaluate the void content ratio with high accuracy.

Respective functions described in the present disclosure may be implemented by one or plural processing circuits. The processing circuits include programmed processors, electrical circuits, etc., as well as devices such as application specific integrated circuits (ASIC) and circuit components arranged to perform the described functions, etc.

According to the present disclosure, it is possible to identify voids contained in a composite material including reinforcing material and matrix, and to evaluate the void content ratio with high accuracy. As a result, it is possible to promote the production of high-quality composite materials. Therefore, it is possible to contribute to, for example, Goal 9 of the Sustainable Development Goals (SDGs) led by the United Nations, “Build resilient infrastructure, promote inclusive and sustainable industrialization and foster innovation.”

Although some embodiments have been described, it is possible to modify or transform the embodiments based on the above disclosure contents. All components of the above embodiment, and all the features described in the claims, may be individually extracted and combined as long as they do not contradict each other.

1. An identification device comprising:
a receiver configured to receive a physical quantity distribution inside a member into which a reinforcing material has been molded, and
a controller configured to identify voids contained in the member based on the physical quantity distribution,
wherein the controller
receives the physical quantity distribution of the member before impregnating matrix as a first physical quantity distribution through the receiver,
receives the physical quantity distribution of the member after impregnating the matrix as a second physical quantity distribution through the receiver,
performs a first threshold processing based on the first physical quantity distribution to generate a first structure data indicating a structure of the reinforcing material inside the member,
performs a second threshold processing based on the second physical quantity distribution to generate a second structure data indicating a structure of the matrix inside the member,
generates a synthetic data by superimposing the first structure data and the second structure data, and
identifies the voids inside the member after impregnating the matrix based on the synthetic data.

2. The identification device according to claim 1, wherein the controller generates the synthetic data by superimposing the first structure data and the second structure data on a basis of a design data of the member or a three-dimensional measurement data of the member.

3. The identification device according to claim 1, wherein the controller
performs a morphology processing on the synthetic data obtained by superimposing the first structure data and the second structure data to generate a modified synthetic data, and
identifies the voids based on the modified synthetic data.

4. The identification device according to claim 1, wherein the matrix has a higher specific gravity than the reinforcing material.

5. The identification device according to claim 1, wherein the reinforcing material is made of a plurality of fiber bundles.

6. The identification device according to claim 1, wherein the receiver receives as the physical quantity distribution a distribution representing an absorbance of X-rays at each point inside the member, the distribution being acquired by an X-ray Computed Tomography device.

7. An identification method for identifying voids contained in a member based on a physical quantity distribution inside the member into which a reinforcing material has been molded, comprising:
receiving the physical quantity distribution of the member before impregnating matrix as a first physical quantity distribution,
receiving the physical quantity distribution of the member after impregnating the matrix as a second physical quantity distribution,
performing a first threshold processing based on the first physical quantity distribution to generate a first structure data indicating a structure of the reinforcing material inside the member,
performing a second threshold processing based on the second physical quantity distribution to generate a second structure data indicating a structure of the matrix inside the member,
generating a synthetic data by superimposing the first structure data and the second structure data, and
identifying the voids inside the member after impregnating the matrix based on the synthetic data.

8. A non-transitory computer-readable storage medium storing a program for causing a computer to execute processing for identifying voids contained in a member based on a physical quantity distribution inside the member into which a reinforcing material has been molded,
the processing comprising:
receiving the physical quantity distribution of the member before impregnating matrix as a first physical quantity distribution,
receiving the physical quantity distribution of the member after impregnating the matrix as a second physical quantity distribution,
performing a first threshold processing based on the first physical quantity distribution to generate a first structure data indicating a structure of the reinforcing material inside the member,
performing a second threshold processing based on the second physical quantity distribution to generate a second structure data indicating a structure of the matrix inside the member,
generating a synthetic data by superimposing the first structure data and the second structure data, and
identifying the voids inside the member after impregnating the matrix based on the synthetic data.
